(19) United States
(12) Patent Application Publication
(10) Pub. No.: US 2005/0008998 A1
(43) Pub. Date: Jan. 13, 2005

(54) System and method for providing certified proctors for examinations

(76) Inventor: Chad B. Munger, Chicago, IL (US)

Correspondence Address: VEDDER PRICE KAUFMAN & KAMMHOLZ, 222 N. LASALLE STREET, CHICAGO, IL, 60601, US

(21) Appl. No.: 10/617,101

(22) Filed: Jul. 10, 2003

(51) Int. Cl. G09B 3/00

(52) U.S. Cl. 434/350

(57) ABSTRACT

Certified proctors administer proctored examinations on behalf of unrelated testing authorities. A certified proctor is a person who has been qualified to administer examinations according to instructions of diverse testing authorities. In general, a proctoring service provides certified proctors to administer examinations on an as-needed basis. In one embodiment, certified proctors can be requested by Internet/web-based communications.

### FIELD OF THE INVENTION

This invention relates generally to a system and method for recruiting, certifying and assigning human proctors to examination takers at local points of examination.

### BACKGROUND OF THE INVENTION

There are many organizations that need to establish or determine whether a person has satisfactorily completed a course of education, training, and/or experience. Other organizations condition an individual's entry, or affiliation with them, on an individual's education, training and/or experience as measured by an examination. Examinations like entrance examinations, qualifying examinations and certification examinations, typically test an individual's experience, knowledge, proficiency or competency in one or more subjects, abilities, etc.

Proctored examinations provide a reliable method for establishing the identity of an individual taking an examination, for ensuring compliance with rules governing the administration of a particular examination, e.g., no use of outside reference material or stimuli and maintaining the security and confidentiality of the examination questions. Proctored examinations tend to be delivered during discreet, time-limited periods to minimize the possibility of sharing of examination content and strategy between examinees.

In the prior art, organizations that administer a qualification or entrance examinations provide their own exam proctors. Proctored examinations are usually held in one or more established commercial or proprietary testing centers, and often with limited testing dates. Proctored examinations are also delivered by leasing large common spaces in strategically located metropolitan areas.

Prior art methods for proctoring have drawbacks, including the costs (both real and opportunity) incurred by both examinees and testing authorities when examinations are delivered in centralized locations. A method for proctoring examinations more frequently or on demand, at convenient locations, and would be an improvement over the prior art.

### BRIEF DESCRIPTION OF THE DRAWINGS

FIG. 1 shows a system for providing certified proctors to administer examinations.

FIG. 2 shows steps of a method for providing certified proctors for an examination.

FIG. 3 depicts a web-based implementation of a proctoring service.

### DETAILED DESCRIPTIONS OF THE PREFERRED EMBODIMENTS

In a preferred embodiment of the invention, individuals who are certified proctors of examinations are provided to one or more testing authorities to proctor examinations on behalf of the testing authorities. The certified proctors and any proctoring service provider for which they work are both wholly independent of the testing authorities, i.e., the proctors and the proctor service are “unaffiliated” with the testing authorities.

Testing authorities can include entities such as schools, professional organizations, Federal, state, county and municipal governmental agencies. The testing authorities have their respective examinations administered under the auspices of the certified proctors, at either central testing locations, in an examinees' place of employment, residence or other location, which can be specified by either the examinee, the proctor or the testing authority.

“Certified proctors” are individuals who have been tested for their ability to conform the administration of an examination to different testing criteria required of different testing entities. In addition to testing a person's ability to conform the administration of a test, prospective certified proctors are also “certified” by the completion of background investigation and a determination there from that the individual has not been convicted of criminal conduct, is over-extended financially. Individuals who have mental or physical disabilities can also be disqualified from consideration as a “certified proctor.”

In some embodiments, individuals are certified by way of training in the administration of examinations. Such training would include appropriate and lawful ways to establish the identity of an examinee; lawful ways to insure that examinees do not engage in prohibited communications during an examination; lawful ways to insure that examinees do not receive prohibited assistance during an examination. Training can also be provided in lawful ways to recover test materials and questions from examinees; detecting when an examinee is, or might be, copying test questions or test materials and the protection of test materials from unauthorized copying and distribution.

“Certified proctors” therefore include individuals who have been tested for their ability to administer an examination. They preferably do not have prior arrests and/or convictions. They do not have mental or physical defects.

Although a “certified proctor” can also be a classroom teacher or instructor, whose employment scope includes conducting regular classes teaching or training, a classroom teacher who has not demonstrated an ability to administer examinations and whose background has not been checked for suitability as a proctor is not considered to be a “certified proctor.”

Training to be a proctor would include appropriate and lawful ways to establish the identity of an examinee; lawful ways to insure that examinees do not engage in prohibited communications during an examination; lawful ways to insure that examinees do not receive prohibited assistance during an examination. Training to become a certified proctor can also include methods of detecting and preventing copying, transcription and/or theft of examination questions and/or other examination materials by putative examinees. Training can include methods to securely distribute examination questions and materials and to securely recover test results and test materials to preserve the security and confidentiality of test results and test questions on behalf of testing authorities.

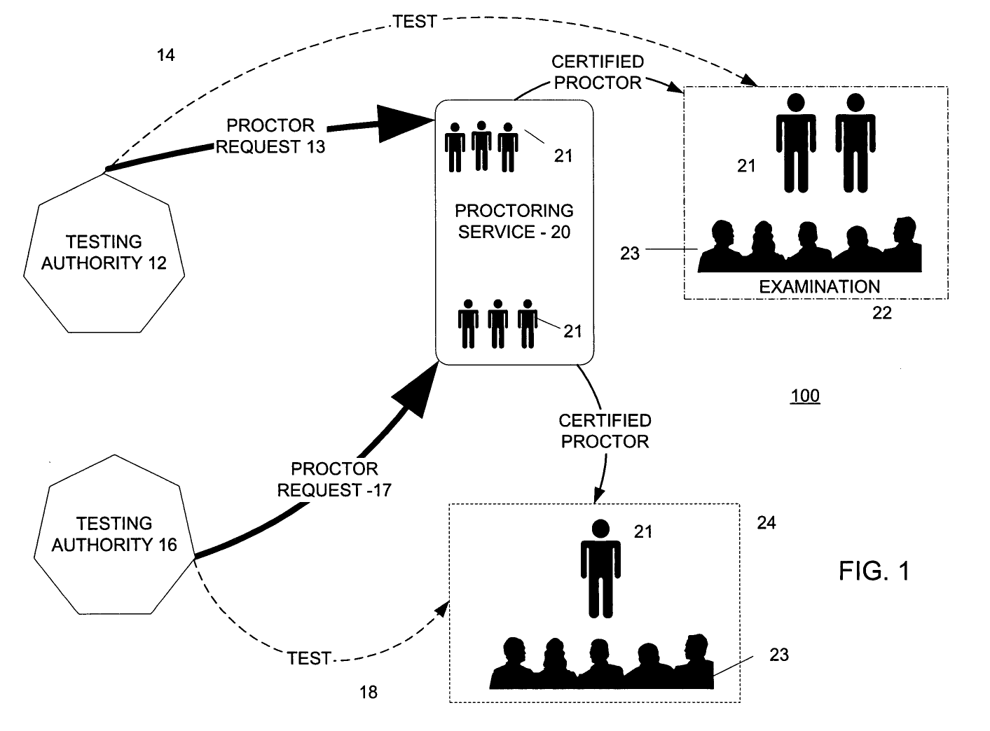

FIG. 1 is a depiction of a business method 100 that is the provision of certified proctors 21 by a proctoring service 20. The certified proctors 21 are individuals who have been investigated, tested and trained to administer examinations on behalf of testing authorities 16 and 18 that are wholly unrelated to the proctoring service 20 and each of the proctors 21 employed by the proctoring service 20.

In FIG. 1, testing authorities 12, 16 that wish to administer an examination that needs to be proctored, engage the services of a proctoring service 20 by way of a web-hosted communication, telephone call or written engagement letter. A testing authority can contact and engage the proctoring service 20 whenever the testing authority needs to administer an examination.

By way of example, a testing authority 12 that is a school, sends a request 13 to the proctoring service 20 for a proctor 21 to administer 14 an entrance examination on behalf of the testing authority school. In response, the proctoring service 20 provides one or more proctors 21, who administer an entrance examination 22 at a date, time, and/or location specified by either the testing authority 12, the proctoring service 20, and/or the examinees 23 on behalf of the testing authority 12 and using any instructions and materials required by the testing authority. As part of the proctoring service or at the request of the testing authority, the proctor 21 or the proctor service 20 can procure facilities in which to administer an examination. In order to insure the conformance to the testing authority's instructions, the proctors 21 who are provided to administer the examination 22 on behalf of the testing authority 12 preferably have no business with or employment by the testing authority or with any of the examinees. In addition, the proctors 21 have no financial interest in the testing authority 12 nor does the proctor have any financial interest in or with any of the examinees 23. By way of example, the proctors 21 provided to proctor the examination 22 are preferably from another community or geographic area and unknown to the examinees 23 and the testing authority 12. A certified proctor who has no financial or other relationship with the testing authority is therefore considered to be unaffiliated with the testing authority.

A second testing authority 16, such as a state professional certification organization, or law enforcement agency can send a second request 17 to the proctoring service 20 for one or more proctors 21 to administer 18 a different examination, such as bar exam for prospective lawyers, or a qualification test for prospective law enforcement officers.

In response to the second request to the proctoring service 20 for a proctor 21, the proctoring service 20 provides yet another proctor 21, or even the same proctor for the aforementioned examinations. School entrance examinations, professional certification examinations or any other examination 24 can be offered on many different dates, times and/or locations that can be specified by either the testing authority, the proctoring service 20, and/or the examinees 23. Inasmuch as certified examination proctors 21 are provided by the proctor service 20 to testing authorities on an as-needed, where-needed basis, examinations can be offered more often, more conveniently and at less cost. By using certified proctors on an as-needed basis to entities that regularly and frequently need to administer proctored examinations, and who are unknown to the examinees, test objectivity, accuracy and test security can be significantly increased as compared to using employees of the testing authority.

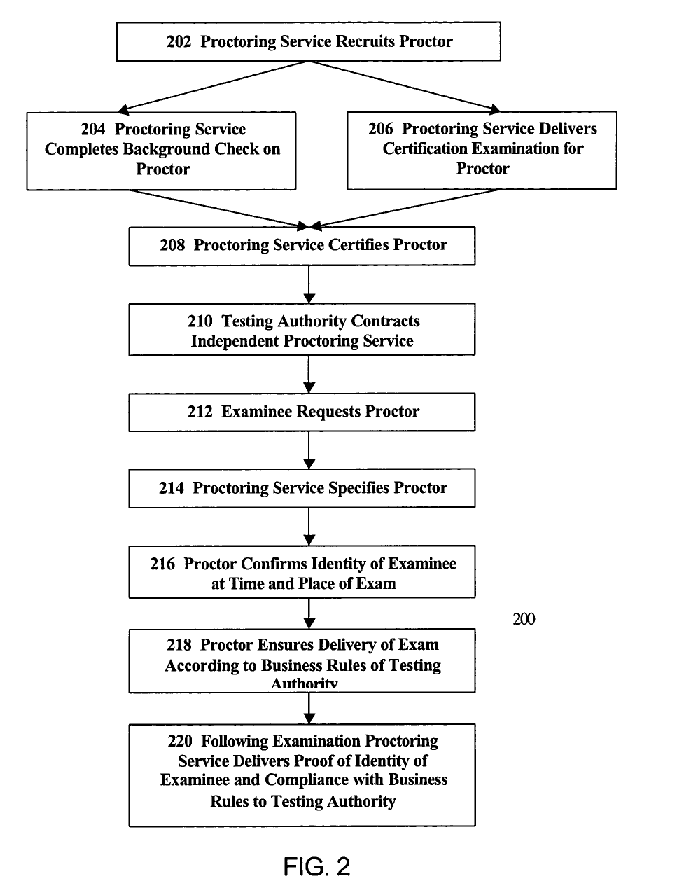

FIG. 2 shows steps of a method 200 of a providing certified proctors for administering examinations.

In step 202, a proctoring service provider 20 can recruit or solicit individuals as possible certified proctors 21. Recruiting a person to be a certified examination proctor can be accomplished a number of ways including, but not limited to, directly soliciting persons by way of a direct mailing, direct telephone call, an e-mail message, but also be an advertisement, such as an advertisement in a newspaper, on a television commercial or commercial broadcast radio channel.

In a preferred embodiment, in step 204, the backgrounds of prospective examination proctors 21 are investigated prior to their retention/employment in order to identify whether a prospective examination proctor might be unsuitable, or subject to influence, bribery or duress. Factors to consider in certifying a person as fit to proctor examinations for third parties include prior arrests or prior convictions for criminal offenses; mental and physical health, credit history, assets, prior employment relationships, length of time in a community. In as much as examination proctoring requires a proctor to be honest and resistant to bribery and/or duress, an individual's prior criminal conduct, financial duress, and mental imbalance can indicate that a person might be ill-suited to act as an examination proctor. Transients and individuals having poor performance in prior employment relationships might also be ill-suited to proctor examinations.

In step 206, an examination is given to prospective examination proctors who are not rejected in step 204. The proctor certification test administered in step 206 is preferably psychometrically valid, reliable, and sensitive to those measurement domains that insure a proctoring candidate has a fundamental knowledge of testing processes, goals and security. Psychometrics is known to be a science of cognitive testing.

The sequence of steps 204 and 206 with respect to each other is a design choice. In other words, step 206 could be performed prior to, after, or simultaneously with step 204.

Not shown in FIG. 2, is a step of providing appropriate training, which can be provided as part of step 204 and/or step 206 by which proctors 21 can be trained to administer tests, including lawful and effective methods of identifying examinees and conforming their conduct to instructions of the testing authority. Proctor training can be provided by the proctor service 20, or by another entity so that upon completion of training, a proctoring candidate can demonstrate sufficient knowledge, competence and/or skill to successfully complete the proctor certification examination.

Upon completion of the background check of step 204 and successful completion of the proctoring certification examination of step 206, an individual is considered certified in step 208. A certified examination proctor 21 is therefore a person who has passed an examination that establishes the person's ability to understand rules of test administration that will be provided by third-party testing authorities; be able to recognize examinees who violate examination rules; are trustworthy and dependable employees, not subject to duress, bribery or prone to commit extortion upon examinees.

In step 210, a testing authority 12 or 16 needing to administer a proctored examination contacts the proctoring service 20. “Testing authorities” are considered herein to be entities that need to administer tests and that are empowered, authorized or permitted to qualify, certify, admit or otherwise determine the knowledge, skill, background, education or suitability of a person for a particular task, qualification or purpose. Examples of testing authorities include: schools, governmental and/or law enforcement and public safety agencies, trade unions, and professional certifying and credentialing organizations which needs to administer a proctored examination. Testing authorities would also include employers that wish to screen applicants or qualify employees. By engaging certified examinations proctors 21, who are engaged only for proctoring an examination, test administration costs are lowered, even when examinations are provided at more locations, that are convenient to the examinees as well as the testing authority than is possible by using full-time or part-time employees of a testing authority. By using proctors that are certified by a third party as set forth above, the administration of examinations is more likely to be performed consistently. The increased anonymity of certified proctors can also improve security by having a different person proctor different examinations for a particular testing authority.

In step 212, an examinee can request a testing authority for a proctored examination to be administered at a particular time or location although in most instances, a testing authority will request a proctor for an examination. Individual examinees eligible to take part in a proctored examination being delivered by a testing authority can request an examination proctor by using web-based communication with the testing authority, the telephone or written communication to request a proctor to oversee the administration of an instance of an exam at a given time and place. The testing authority can thereafter obtain one or more proctors as needed to administer a proctored examination to an individual.

In step 214, an examination proctoring service 20 provides a proctor to a testing authority. Providing a proctor will often include accepting from the testing authority, test materials and test administration instructions and requirements from the testing authority. As part of a proctoring service, a suitable location for the examination is obtained by the proctoring service 20, an examinee 23 or the testing authority 12 or 16, and on the date of an examination, one or more certified proctors 21 administer the examination according to the testing authority's 12 or 16 instructions.

In one embodiment, certified proctors 21 can administer examinations at an examinee's residence. In instances where an examinee is considered disabled under the Americans with Disabilities Act but otherwise qualified, a certified proctor 21 can be provided by the proctoring service 20 to accommodate needs of the otherwise qualified examinee. For example, a certified proctor 21 can administer a test orally to the visually impaired; using sign language to the hearing impaired; with additional time, or in an isolated environment to those who suffer from attention deficit disorder.

In step 216, at the time of an examination, the certified proctor 21 will request or demand as appropriate, sufficient information from each examinee 23 so as to determine the identity of each person taking an examination.

In step 218, after the identity of each examinee has been established the proctor administers the examination to the examinee according to the testing authority, e.g., completion in a specified period of time, no use of outside materials or stimuli, no talking or interacting with others, periodic monitored restroom breaks, etc. Following completion of the examination the proctor secures the exam content according to the testing authority and returns all relevant materials including examination material, examination results, and material related to the identification and securing of the examination site, to the testing authority either directly or through the proctoring service.

In step 220, a proctor optionally requires examinees to confirm their identities using, among other things, photo identification, finger prints, hair sample, retinal scan, etc.

The salient aspect of the system and method disclosed herein is the temporary engagement of one or more individuals, whose backgrounds have been checked and who have tested to be determined as competent to administer examinations for unrelated entities, and trained to do so if necessary. They can be provided on an as-needed basis to administer examinations on behalf of testing authorities. Fees are paid to the proctor 21 or a proctor service 20 for the proctoring service that is rendered.

By way of example, a proctoring service 20 that employs several, certified examination proctors 21, can provide one or more of its examination-proctoring employees (i.e., the aforementioned “certified proctors”) to proctor a particular test 22 for a particular testing authority 12 at a particular time on a particular day at a particular location. On a subsequent day, the same examination proctor 21 can administer a different test 14, for a different entity 16 at a different location.

In another example, a proctoring service 20 can provide a particular examination proctor 21 to administer a particular test for a particular testing authority 12 at a particular time on a particular date. The proctoring service 20 can then provide the same proctor 21 or a different proctor 21, to the same testing authority, to administer the same test, or perhaps a different test, on a different date at the same time, or at a different time.

In yet another example, a proctoring service 20 can provide a particular proctor, to administer a particular examination for a particular entity at a particular date and/or time. The proctoring service 20 can then provide the same proctor to administer a different test for the same entity, albeit at a second date and/or time, perhaps at a different location.

In still another example, a proctoring service 20 can provide a particular proctor to administer a first test at a first location at a first date and/or time. The proctoring service 20 can also provide a second certified proctor to administer the same test, at the same time, albeit at a second location.

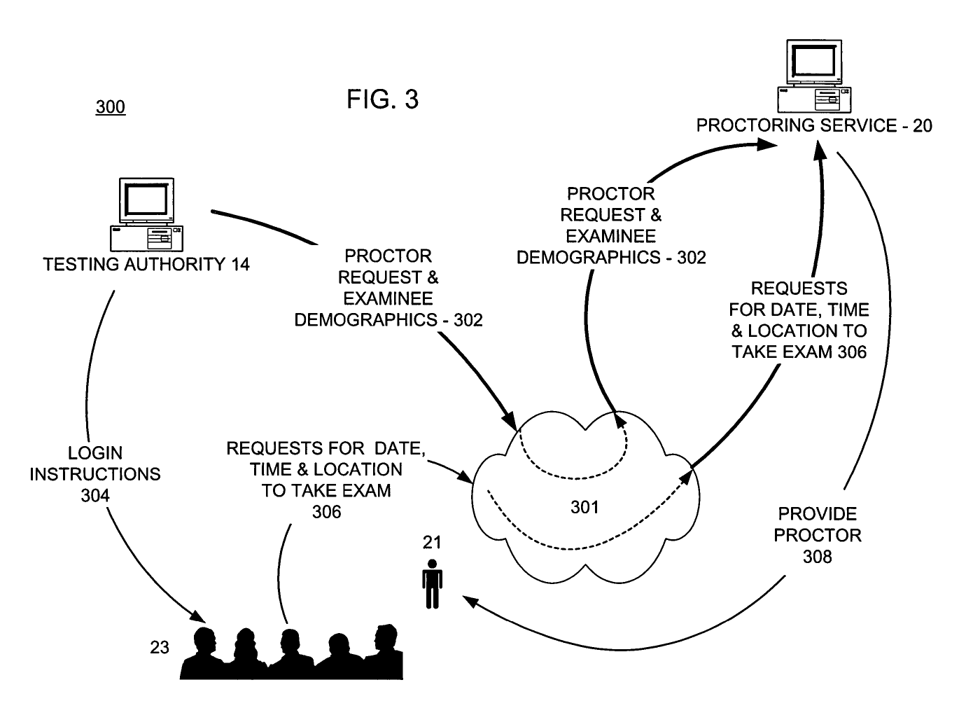

FIG. 3 depicts an implementation 300 of a proctoring service via the Internet/world-wide web 301 whereby certified proctors 21 are provided on an as-needed basis to administer examinations on behalf of testing authorities 14.

To schedule a proctor for an examination, after a testing authority 14 engages the proctoring service 20 for a given examination, the testing authority 14 provides demographic information for eligible examination takers to the proctoring service 20 via a web-based data transfer 302. Such information can include specific information about each examinee. Alternatively, the demographic data can describe or profile examinees. In instances when everyone is eligible to take an examination, there might be no demographic information provided to the proctoring service. Upon receipt of the proctor request and demographic data 302, the proctoring service stores the examinee data in a database (not shown in FIG. 3).

As part of the examination process, the testing authority 14 provides, publishes or otherwise distributes 304 web site login directions to eligible examinees 23 by which the eligible test takers can log onto a web site (not shown, but well known in the art) by which they can choose a date, time and location to take an examination. In a preferred embodiment, the proctoring service provides a web site whereat examinees can request dates, times and locations of an examination.

Using a uniform resource locator (URL) and password information, the prospective examinees 23 log on to a web site (not shown) and upload their requests for dates, times and locations that they would prefer to take the exam by way of another web-enabled data exchange 306. The examination request data can be passed to both the testing authority 14 and the proctoring service 20, but inasmuch as the proctoring service 20 is providing the proctors, the requests for examination dates, times and locations needs to be provided to the proctoring service 20.

Included with the demographic data 302 and/or the request data 306 is information that can effectively locate examinees (address, phone numbers, ZIP code etc.). Using this information, the proctoring service 20 automatically assigns the nearest available proctor 21 as identified by proctor-identifying information resident in a proctor database of the proctoring service. In a preferred embodiment, the selected proctor 21 is provided with the demographic data of examinees, the requests for dates, times and locations, special needs of the examinees and test materials 308. A geographically-convenient proctor, is selected to administer an examination is also matched to special needs that may have been indicated by the testing authority in the demographic data 302.

On the day of the examination, the proctor 21 administers the examination to the examinees 23 and upon conclusion of the examination, collects all materials used to administer the examination for return to the testing authority for grading and test security.

From the foregoing it should be apparent that the certified proctors are engaged to administer examinations by any testing authority, to a variety of examinees under a variety of circumstances on an as-needed basis. As is well known, the scope of the invention is set forth in the following claims.

By screening, testing, and training individuals to proctor examinations, the cost to provide a proctored examination can be reduced. The times and locations where proctored examinations are offered can be more varied. The frequency at which a proctored examination is offered can be increased. One or more certified proctors 21 can be hired on a temporary basis, by one or more entities. Because the certified proctors are unaffiliated with the testing authority, they are unable to provide assistance to examinees for any reason. By renting the services of proctors on an as-needed, where-needed basis, a proctoring service 20 can provide proctors on a fee basis, reducing the overhead cost to and increasing the profitability of the testing authority.

1. A method of administering proctored tests for a testing authority comprised of:
providing a first certified proctor to proctor a first test for the first testing authority at a first time, said first certified proctor being unaffiliated with the testing authority.

2. A method of administering proctored tests for a testing authority comprised of:
providing a plurality of certified proctors to proctor a first test for the first testing authority at a first time, each proctor of said plurality of certified proctors being unaffiliated with the testing authority.

3. A method of administering proctored tests for first and second, unrelated testing authorities comprised of:
providing a first certified proctor to proctor a first test for the first testing authority at a first time; and
providing the first certified proctor, to proctor a second test for the second testing authority at a second time.

4. A method of administering proctored tests for unrelated testing authorities comprised of:
providing a first certified proctor, to proctor a first test for a first testing authority at a first time at a first location; and
providing the first certified proctor, to proctor a second test for a second testing authority at a second time at a second location.

5. A method of administering proctored tests for testing authorities comprised of:
providing a first certified proctor, to proctor a first test for a first testing authority at a first time; and
providing the first certified proctor, to proctor the first test for the first testing authority at a second time.

6. A method of administering proctored tests for testing authorities comprised of:
providing a first certified proctor, to proctor a first test for a first testing authority at a first time; and
providing the first certified proctor, to proctor a second test for the first testing authority at a second time.

7. A method of administering proctored tests for a testing authority, the method comprised of:
providing a first certified proctor, to proctor a first test at a first time at a first location; and
providing a second certified proctor, to proctor a said first test at said first time at a second location;
said first certified proctor and said second certified proctor being independent of the testing authority.

8. The method of claim 1 wherein the step of providing a first certified proctor is comprised of:
determining whether an individual has a criminal background; and
administering a qualification exam to the individual to determine the ability of the individual to conform to test administration standards of unrelated testing authorities.

9. The method of claim 2 wherein the step of providing a plurality of certified proctors is comprised of:
determining whether each individual of a plurality of individuals has a criminal background; and
administering a qualification exam to each individual to determine the ability of each individual to conform to test administration standards of unrelated testing authorities.

10. The method of claim 3 wherein the step of providing a first certified proctor is comprised of:
determining whether an individual has a criminal background; and
administering a qualification exam to the individual to determine the ability of the individual to conform to test administration standards of unrelated testing authorities.

11. The method of claim 4 wherein the step of providing a first certified proctor is comprised of:
determining whether an individual has a criminal background; and
administering a qualification exam to the individual to determine the ability of the individual to conform to test administration standards of unrelated testing authorities.

12. The method of claim 5 wherein the step of providing a first certified proctor is comprised of:
determining whether an individual has a criminal background; and
administering a qualification exam to the individual to determine the ability of the individual to conform to test administration standards of unrelated testing authorities.

13. The method of claim 6 wherein the step of providing a first certified proctor is comprised of:
determining whether an individual has a criminal background; and
administering a qualification exam to the individual to determine the ability of the individual to conform to test administration standards of unrelated testing authorities.

14. The method of claim 7 wherein the step of providing a first certified proctor is comprised of:
determining whether a first individual has a criminal background; and
administering a qualification exam to the first individual to determine the ability of the first individual to conform to test administration standards of unrelated testing authorities.

15. A method of administering proctored tests for a testing authority, the method comprised of:
receiving a request for a certified proctor via a web-based data transfer; and
upon receipt of the request for a certified proctor, providing a certified proctor on a date and time and at a location.

16. The method of claim 15 further comprising the step of:
receiving examinee demographic data prior to the step of providing a certified proctor.

17. The method of claim 16 further comprising the step of:
identifying a geographically convenient proctor from examinee demographic data.
